(19) United States
(12) Patent Application Publication
(10) Pub. No.: US 2004/0202858 A1
(43) Pub. Date: Oct. 14, 2004

(54) Electronic device protective cover equipped with expansion functions

(75) Inventor: Chih Wei Lee, Yung-He City (TW)

Correspondence Address: MERCHANT & GOULD PC, P.O. BOX 2903, MINNEAPOLIS, MN, 55402-0903, US

(73) Assignee: Mitac International Corp., Hsinchu (TW)

(21) Appl. No.: 10/133,850

(22) Filed: Apr. 25, 2002

(51) Int. Cl. B32B 1/00; H04B 1/38

(52) U.S. Cl. 428/332; 428/337; 455/66.1; 455/90.3; 455/575.1

(57) ABSTRACT

An electronic device protective cover equipped with expansion functions may be coupled with an electronic device (such as a PDA) to protect the surface of the electronic device. The protective cover has at least one built-in expansion section to couple with the electronic device and allow the electronic device to obtain external expansion functions through the expansion section.

### FIELD OF THE INVENTION

The invention relates to an electronic device protective cover equipped with expansion functions, and particularly a protective cover to couple with a Personal Digital Assistant (PDA), a handheld computer or the like, for protecting the surface of the device.

### BACKGROUND OF THE INVENTION

The rapid development of wireless communication and flooding of new products on the market have radically changed methods of interpersonal communication. Nowadays, the PDA, because it has a wide variety of functions such as wireless data transmission, personal notebook, wireless telephone, flash memory and facsimile data processing, can easily help people to reduce the burden and time for processing daily chores.

With the open system architecture of PDAs, expandability has become an essential basic function. This is mainly because the available and applicable software for PDAs is numerous, and there is a need to store a large amount of data. In the event a PDA does not have enough built-in memory capacity, various expansion slots provided on the device body can be used to connect external expansion cards to resolve memory shortage problems. Moreover, in order to satisfy ever increased functional requirements, and non-uniform expansion technologies and specifications, many PDA producers have now included expansion slots of different specifications to allow the PDA device body to support more expansion cards.

With PDA functions continually growing, manufacturing complexity also increases. The device also becomes thicker as more functional accessories are added. This is contrary to the lean and light direction that most products are headed.

### SUMMARY OF THE INVENTION

In view of aforesaid disadvantages, the primary object of the invention is to provide electronic devices such as PDAs more expansion capability while still maintaining lean and light characteristics.

In order to achieve the foregoing object, the invention provides an electronic device protective cover equipped with expansion function capabilities. The protective cover is especially made for electronic devices and includes at least one expansion section. The expansion section may connect external expansion cards or peripheral devices to allow an electronic device to obtain external expansion functions, thereby overcoming the problem of increasing size resulting from adding expansion functions.

The foregoing, as well as additional objects, features and advantages of the invention will be more readily apparent from the following detailed description, which proceeds with reference to the accompanying drawings. The drawings are only to serve for reference and illustrative purposes, and are not intended to limit the scope of the invention.

### BRIEF DESCRIPTION OF THE DRAWINGS

FIG. 1 Is a perspective view of a protective cover of the invention.

FIG. 2 is a schematic view of the protective cover of the invention coupled with an electronic device.

### DESCRIPTION OF THE PREFERRED EMBODIMENT

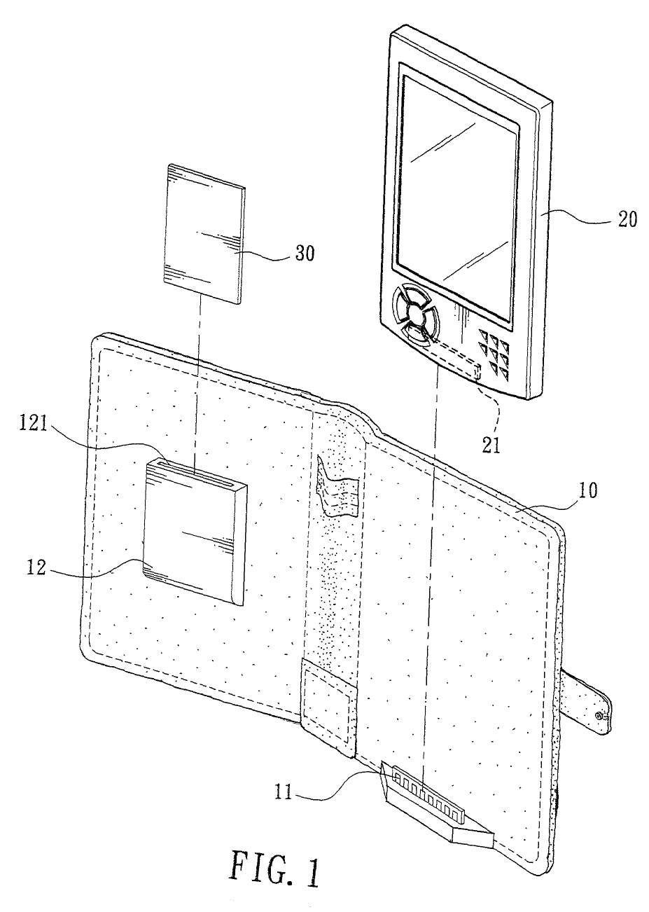

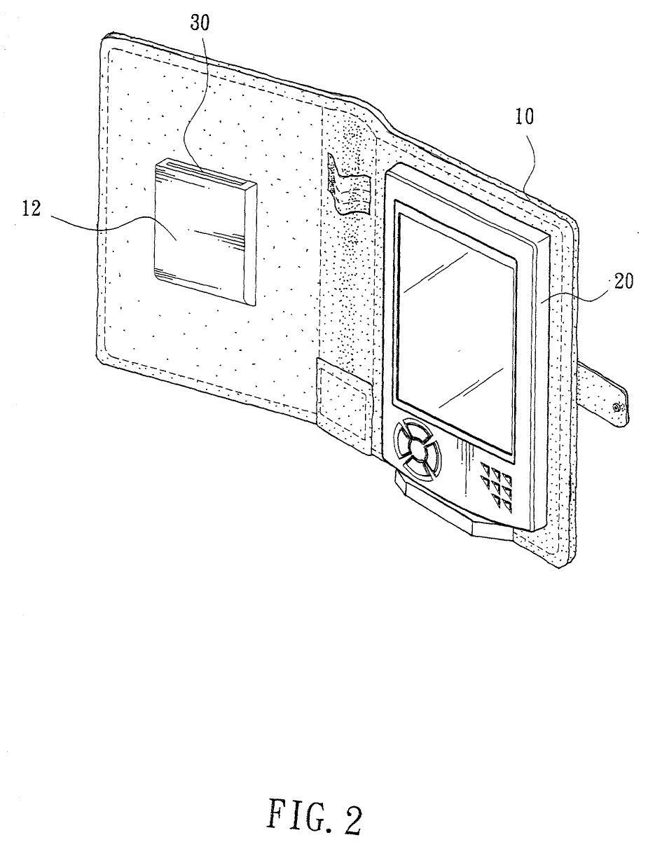

The invention aims to provide a special protective cover to couple with an electronic device such as PDA, handheld computer and the like, which can also protect the device surface. Please refer to FIGS. 1 and 2 for a preferred embodiment of the protective cover of the invention. The protective cover 10 is foldable and may be coupled with an electronic device 20, or may encase the electronic device 20. It may be made in the form of a general wallet. The protective cover 10 has a built-in first connection port 11 and at least one expansion section 12, which is linked to the first connection port 11 through a printed circuit (not shown in the drawing) embedded in the inner layers of the protective cover 10 for establishing electric connection. The first connection port 11 may be coupled with a second connection port 21 built in the electronic device 20, such that the electronic device 20 may couple with the protective cover 10 through the connection of the connection ports 11 and 21. Through the second connection port 21, the electronic device 20 utilizes the externally connected expansion functions provided by the expansion section 12.

The expansion section 12 may be made in the form of a memory card slot 121 with various specifications to receive a CF card (Compact Flash Card), SD card (Secure Digital Memory Card), and MMC Card (Multi Media Card), as disclosed in the invention. Hence the electronic device 20 may couple with an expanded memory card 30 in the expansion section 12 to perform data retrieval operations. In addition, the expansion section 12 may also link to the interface connection ports of peripheral devices such as printers.

By means of the construction set forth above, when the electronic device 20 is coupled with the protective cover 10, it can obtain the external expansion functions of expansion cards or peripheral devices through the expansion section 12. The electronic device 20 held in the protective cover 20 thus does not need to add more built-in expansion slots to increase expandability. As a result, the electronic device may maintain its lean and light characteristics without becoming too bulky or too thick, and keep utilization convenience.

While the preferred embodiment of the invention has been set forth for the purpose of disclosure, modifications of the disclosed embodiment of the invention as well as other embodiments thereof may occur to those skilled in the art. Accordingly, the appended claims are intended to cover all embodiments which do not depart from the spirit and scope of the invention.

What is claimed is:

1. An electronic device protective cover equipped with expansion functions, comprising:
a protective cover having a first connection port to couple with a second connection port built in an electronic device; and
an expansion section built in the protective cover and connected the first connection port electrically to provide the electronic device an external expansion function.

2. The electronic device protective cover equipped with expansion function of claim 1, wherein the protective cover is a foldable cover to encase the electronic device.

3. The electronic device protective cover equipped with expansion function of claim 1, wherein the expansion section is a memory card slot.

4. The electronic device protective cover equipped with expansion function of claim 1, wherein the expansion section is an interface connection port for linking a peripheral device.
